(19) United States
(12) Patent Application Publication
(10) Pub. No.: US 2026/0360955 A1
(43) Pub. Date: Nov. 12, 2026

(54) ELECTRODE FOR SECONDARY BATTERY AND SECONDARY BATTERY INCLUDING THE ELECTRODE

(71) Applicant: SAMSUNG SDI CO., LTD., Yongin-si (KR)

(72) Inventors: Misun LEE, Yongin-si (KR); Daesung RO, Yongin-si (KR)

(21) Appl. No.: 19/671,609

(22) Filed: May 8, 2026

(30) Foreign Application Priority Data
May 12, 2025 (KR) 10-2025-0061253

(51) Int. Cl. H01M 50/586; H01M 10/42; H01M 50/536

(52) U.S. Cl. CPC H01M 50/586; H01M 10/4235; H01M 50/536

(57) ABSTRACT

An electrode for a secondary battery includes a composite portion including a first insulating layer, a first substrate disposed on the first insulating layer, and an active material layer disposed on the first substrate. The electrode also includes a protrusion portion including a second insulating layer extending in a first direction from the first insulating layer and a second substrate disposed on the second insulating layer. A thickness of the first insulating layer in a second direction intersecting the first direction is greater than a thickness of the second insulating layer in the second direction.

### CROSS-REFERENCE TO RELATED APPLICATION

The present application claims priority to and the benefit of Korean Application No. 10-2025-0061253, filed on May 12, 2025, in the Korean Intellectual Property Office, the entire disclosure of which is incorporated by reference herein.

### BACKGROUND

### Field

The present disclosure relates to an electrode for a secondary battery and a secondary battery including the electrode.

### Description of the Related Art

Unlike primary batteries that are not designed to be recharged, secondary (or rechargeable) batteries can be discharged and recharged. Low-capacity secondary batteries are used in small portable electronic devices, such as smart phones, feature phones, notebook computers, digital cameras, and camcorders. Large-capacity secondary batteries are widely used as power sources for driving motors in hybrid vehicles and electric vehicles and for storing power (e.g., home and/or utility scale power storage). A secondary battery generally includes an electrode assembly that includes a positive electrode and a negative electrode, a case accommodating the electrode assembly, and electrode terminals connected to the electrode assembly.

Research and development has been conducted to reduce the weight of the components of secondary batteries and improve the energy density, capacity, and safety of secondary batteries.

The information disclosed in this section is for enhancement of understanding of the background of the present disclosure. It may contain information that does not constitute related or prior art.

### SUMMARY

An object of the present disclosure is to provide an electrode for a secondary battery and a secondary battery including the electrode for solving the above-described problems.

These and other aspects and features of the present disclosure will be described in or will be apparent from the following description of embodiments of the present disclosure.

According to embodiments of the present disclosure, an electrode for a secondary battery includes a composite portion including a first insulating layer, a first substrate disposed on the first insulating layer, and an active material layer disposed on the first substrate, and a protrusion portion including a second insulating layer extending in a first direction from the first insulating layer and a second substrate disposed on the second insulating layer, and a thickness of the first insulating layer in a second direction intersecting the first direction is greater than a thickness of the second insulating layer in the second direction.

A thickness of the first substrate in the second direction may be less than a thickness of the second substrate in the second direction.

The first insulating layer and the second insulating layer may be integral, and the first substrate and the second substrate may be integral.

At least a portion of the second substrate may overlap the first insulating layer in the second direction.

The protrusion portion may comprise a first region and a second region extending from the first region in the first direction.

At least a portion of the second substrate in the second region may bent in the second direction and toward the second insulating layer in the second direction.

A thickness of the second substrate in the second region in the second direction may less than a thickness of the second substrate in the first region in the second direction.

A length of the protrusion portion in a third direction intersecting each of the first direction and the second direction may less than a length of the composite portion in the third direction.

The first insulating layer may comprise at least one of polyethylene terephthalate (PET), polypropylene (PP), polyethylene (PE), polystyrene (PS), polyamide (PI), and/or polyurethane (PU).

The active material layer do not overlap with the protrusion portion in the second direction.

According to embodiments of the present disclosure, a secondary battery includes a case and an electrode assembly accommodated in the case, with the electrode assembly including a first electrode, a second electrode, and a separator disposed between the first electrode and the second electrode, and the first electrode may include a composite portion including a first insulating layer, a first substrate disposed on the first insulating layer, and an active material layer disposed on the first substrate, and a protrusion portion including a second insulating layer extending in a first direction from the first insulating layer and a second substrate disposed on the second insulating layer, and a thickness of the first insulating layer in a second direction intersecting the first direction is greater than a thickness of the second insulating layer in the second direction.

A lead tab may be disposed on the second substrate.

The lead tab may be coupled to the second substrate by welding.

According to embodiments of the present disclosure, because the weight of the electrode for a secondary battery and the amount of metal used are reduced by the insulating layer of the electrode for a secondary battery, the manufacturing cost of the secondary battery may be reduced. In addition, even if damage such as penetration of the battery occurs, short circuits are effectively prevented by the insulating layer, so the stability and life characteristics of the secondary battery may be improved.

According to embodiments of the present disclosure, by reducing the thickness of the electrode tab, a lead tab may be easily coupled.

According to embodiments of the present disclosure, by increasing the thickness of the substrate of the electrode tab, the stability and life characteristics of the secondary battery may be improved.

However, aspects and features of the present disclosure are not limited to those described above, and other aspects and features not mentioned herein will be clearly understood by a person skilled in the art from the detailed description below.

### BRIEF DESCRIPTION OF DRAWINGS

The drawings illustrate embodiments of the present disclosure and further describe aspects and features of the present disclosure together with the detailed description of the present disclosure. The present disclosure should not be construed as being limited to the drawings.

FIG. 1 is an exploded perspective view of a secondary battery according to embodiments of the present disclosure.

FIG. 2 is an exploded perspective view of an electrode assembly according to embodiment of the present disclosure.

FIG. 3 is a plan view of an electrode for a secondary battery according to embodiments of the present disclosure.

FIG. 4 is a cross-sectional view of an embodiment of the electrode for a secondary battery as taken along the cross section defined by line A-A of FIG. 3.

FIG. 5 is a cross-sectional view of an embodiment of the electrode for a secondary battery as taken along the cross section defined by line A-A of FIG. 3.

FIG. 6 is a cross-sectional view of an embodiment of the electrode for a secondary battery as taken along the cross section defined by line A-A of FIG. 3.

FIG. 7 is a cross-sectional view of an embodiment of the electrode for a secondary battery as taken along the cross section defined by line A-A of FIG. 3.

FIGS. 8-10 show steps in a method of manufacturing a secondary battery according to embodiments of the present disclosure.

FIGS. 11-13 show steps of a method of manufacturing an electrode for a secondary battery according to embodiments of the present disclosure.

FIGS. 14-16 show steps of a method of manufacturing an electrode for a secondary battery according to embodiments of the present disclosure.

### DETAILED DESCRIPTION

Hereinafter, embodiments of the present disclosure will be described, in detail, with reference to the accompanying drawings. The terms or words used in the present specification and claims are not to be limited to general or dictionary meanings and should be interpreted in a manner consistent with the technical idea of the present disclosure based on the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B, or A and B, unless otherwise stated. That is, “and/or” includes any or all combinations of a plurality of items enumerated. When "C to D" is stated, it means C or more and D or less, unless otherwise specified.

In the present disclosure, the sizes and relative sizes of layers and regions shown in the drawings may be exaggerated for clarity of description. That is, the sizes shown in the drawings are for convenience and are not limited thereto. In addition, the same reference numerals throughout the specification may refer to the same components.

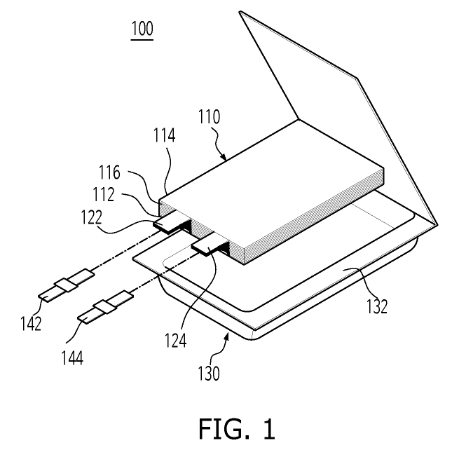

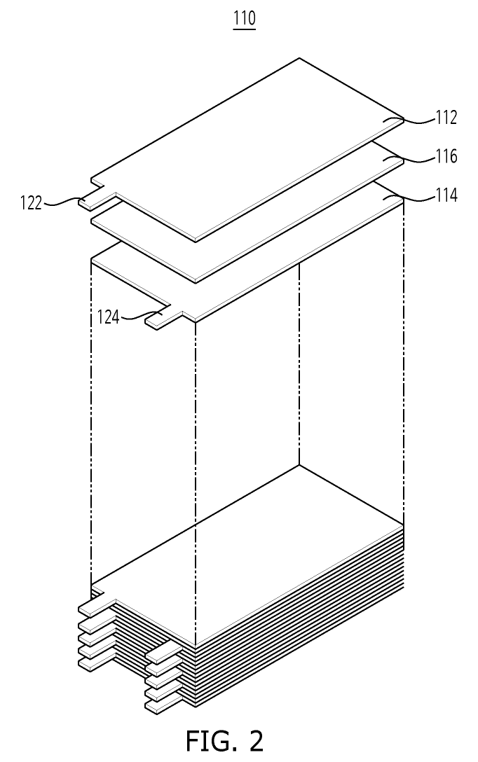

FIG. 1 is an exploded perspective view of a secondary battery 100 according to embodiments of the present disclosure. FIG. 2 is an exploded perspective view of an electrode assembly according to embodiments of the present disclosure. Referring to FIGS. 1 and FIG. 2, a secondary battery 100 may include an electrode assembly 110 and a case 130 in which the electrode assembly 110 is accommodated.

The electrode assembly 110 may include a first electrode 112, a second electrode 114, and a separator 116 disposed between the first and second electrodes 112 and 114. For example, the electrode assembly 110 may be formed by disposing the separator 116, which is an insulator, between the first electrode 112 and the second electrode 114, and then winding the electrodes 112 and 114 and the separator 116. Alternatively, as in the embodiment shown in FIG. 2, the electrode assembly 110 may be formed by stacking separators 116 between first electrodes 112 and second electrode 114s. The first electrode 112 of the electrode assembly 110 may be a negative electrode, and the second electrode 114 may be a positive electrode. Of course, the reverse is also possible.

The first electrode 112 may be formed by applying an active material such as graphite or carbon on a substrate in which an insulating layer formed of an insulating material or a polymer such as polyethylene terephthalate (PET), polypropylene (PP), polyethylene (PE), polystyrene (PS), polyamide (PI), and/or polyurethane (PU) is disposed between a first substrate and a second substrate formed of a metal foil such as copper, a copper alloy, nickel, or a nickel alloy. In addition, the first electrode 112 may include an uncoated portion where the active material is not applied, and a first electrode tab 122 may be disposed on the uncoated portion. Alternatively, the first electrode tab 122 may be a substrate tab formed as a uncoated portion protruding from the first electrode 112.

The first electrode tab 122 may be coupled with a first lead tab 142 of an external terminal to be electrically connected to outside of the battery. For example, the first electrode tab 122 may be coupled with the first lead tab 142 by welding or the like. A tab film for insulation from the case 130 may be attached to the first lead tab 142. However, the present disclosure is not limited to such a configuration, and the electrode tab and the lead tab may be integrally formed.

The second electrode 114 may be formed by applying an active material such as a transition metal oxide on a composite substrate in which an insulating layer formed of an insulating material or a polymer such as PET, PP, PE, PS, PI, and/or PU is disposed between a first substrate and a second substrate formed of a metal foil such as aluminum or an aluminum alloy. The second electrode 114 may include an uncoated portion where the active material is not applied, and a second electrode tab 124 may be disposed on the uncoated portion. Alternatively, the second electrode tab 124 may be formed as an uncoated portion protruding from the second electrode 114.

The second electrode tab 124 may be coupled with a second lead tab 144 of an external terminal to be electrically connected to outside of the battery. For example, the second electrode tab 124 may be coupled with the second lead tab 144 by welding or the like. A tab film for insulation from the case 130 may be attached to the second lead tab 144.

In configuration where the case 130 accommodates the electrode assembly 110, sealing portions 132 at the edges may be brought into contact with each other and sealed. The sealing may be performed with a tab film disposed between the sealing portions 132. The sealing portion 132 may be made of a heat-fusible material, and sealing may be achieved by adhering heat-fusible layers to each other.

In FIG. 1, the case 130 is a pouch-type case and the secondary battery 100 is shown as a pouch-type secondary battery. But the scope of the present disclosure is not limited to such a configuration. The secondary battery 100 may be a secondary battery of any shape such as prismatic or cylindrical.

The secondary battery 100 may be a lithium battery cell, a sodium battery cell, or the like. However, the scope of the present disclosure is not limited to such types of batteries, and the secondary battery 100 includes all batteries that can provide electricity through repeated charging and discharging. When the secondary battery 100 is a lithium battery cell, the secondary battery 100 may be used in an electric vehicle (EV) because of its excellent life characteristics and high-rate characteristics. For example, the secondary battery 100 may be used in a hybrid vehicle such as a plug-in hybrid electric vehicle (PHEV). In other cases, the lithium battery cell may be used in fields that require power storage in various ranges, for example, the lithium battery cell may be used in smartphones, tablet PCs, electric bicycles, power tools, etc.. As such, the present disclosure is not limited with respect to the use of the lithium battery cells as described herein.

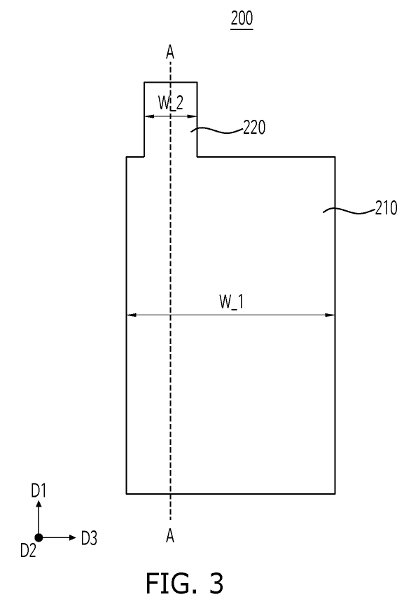

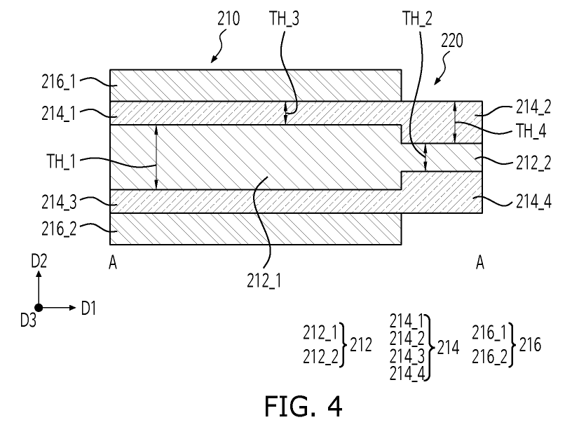

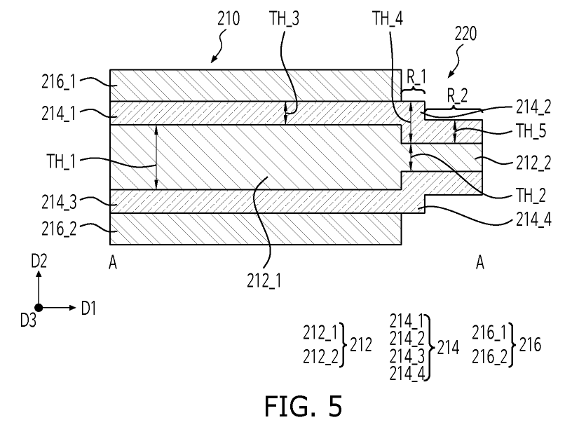

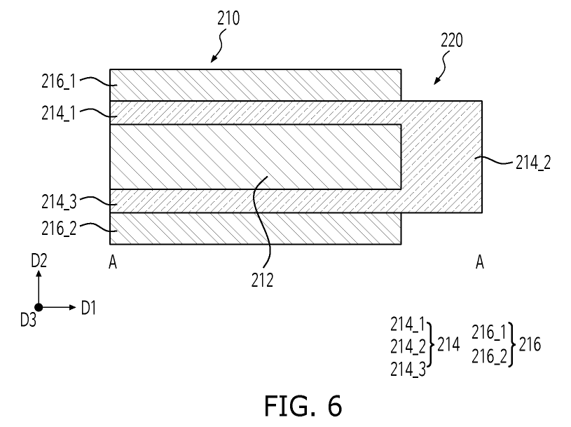

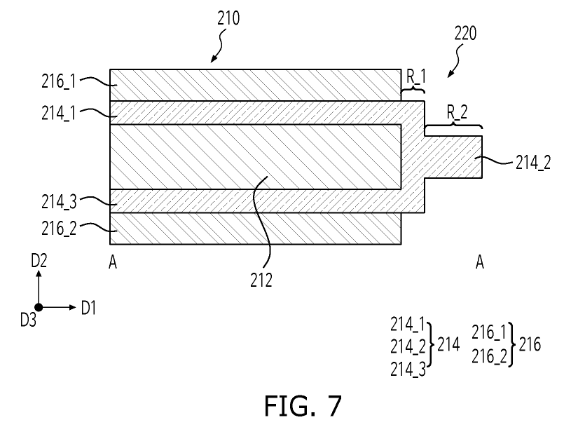

FIG. 3 is a plan view of an electrode 200 for a secondary battery according to embodiments of the present disclosure as viewed from above. FIG. 4 is a view of a first embodiment of the electrode 200 for a secondary battery as taken along a cross section defined by line A-A of FIG. 3. FIG. 5 is a view of a second embodiment of the electrode 200 for a secondary battery as taken along a cross section defined by the line A-A of FIG. 3. FIG. 6 is a view of a third embodiment of the electrode 200 for a secondary battery as taken along a cross section defined by the line A-A of FIG. 3. FIG. 7 is a view of a fourth embodiment of the electrode 200 for a secondary battery taken a cross section defined by the along line A-A of FIG. 3. Here, the electrode 200 for a secondary battery may correspond to the first electrode 112 and/or the second electrode 114 described above with reference to FIGS. 1-2.

Referring to FIGS. 3 and 4, an electrode 200 for a secondary battery may include a composite portion 210 and a protrusion portion 220. The protrusion portion 220 may be formed to extend from the composite portion 210 in a first direction D1. composite A length W_2 of the protrusion portion 220 in a third direction D3 may be less than a length W_1 of the composite portion 210 in the third direction D3. Here, the third direction D3 intersects the first direction D1 and a second direction D2. The protrusion portion 220 may correspond to an electrode tab of the electrode 200 for a secondary battery. For example, when the electrode 200 corresponds to a first electrode (e.g., the first electrode 112 of FIGS. 1 and 2), the protrusion portion 220 corresponds to a first electrode tab (e.g., the first electrode tab 122 of FIGS. 1 and 2).

The composite portion 210 may include a first insulating layer 212_1, a first substrate 214_1, and a first active material layer 216_1. The first insulating layer 212_1 may be formed to extend in the first direction D1. The first insulating layer 212_1 may be formed of any insulating material or polymer including at least one of PET, PP, PE, PS, PI, and PU. The shape of the first insulating layer 212_1 may be a rectangle. But the shape is not limited to a rectangle and may be various other shapes such as any polygon or a circle.

A first substrate 214_1 may be disposed on the first insulating layer 212_1. For example, the first substrate 214_1 may extend in the first direction D1 and be disposed on one surface of the first insulating layer 212_1. In some embodiments, the first substrate 214_1 may cover one surface of the first insulating layer 212_1. The first substrate 214_1 may overlap with the first insulating layer 212_1 in a second direction D2. Here, the second direction D2 intersects the first direction D1. A thickness TH_3 of the first substrate 214_1 in the second direction D2 may be less than a thickness TH_1 of the first insulating layer 212_1 in the second direction D2. The first substrate 214_1 may be formed from a conductive metal material. For example, the first substrate 214_1 may be formed from copper, a copper alloy, nickel, or a nickel alloy. In other examples, the first substrate 214_1 may be formed from aluminum or an aluminum alloy.

A first active material layer 216_1 may be disposed on the first substrate 214_1. For example, the first active material layer 216_1 may extend in the first direction D1 and be disposed on one surface of the first substrate 214_1. In some embodiments, the first active material layer 216_1 may cover one surface of the first substrate 214_1. The first active material layer 216_1 may overlap with the first substrate 214_1 and the first insulating layer 212_1 in the second direction D2, with the first active material layer 216_1 applied on the first substrate 214_1. The first active material layer 216_1 may form a coating portion of the electrode 200 for a secondary battery. The first active material layer 216_1 may include a transition metal oxide or the like. The first active material layer 216_1 may not overlap with the protrusion portion 220 in the second direction D2. That is, the first active material layer 216_1 may extend only to end of the composite portion 210 in the first direction D1.

The protrusion portion 220 may include a second insulating layer 212_2 and a second substrate 214_2. The second insulating layer 212_2 may extend from the first insulating layer 212_1 in the first direction D1. In some embodiments, the first insulating layer 212_1 and the second insulating layer 212_2 may be integrally formed to constitute an insulating layer 212 of the electrode 200 for a secondary battery. The thickness TH_1 of the first insulating layer 212_1 in the second direction D2 may be greater than a thickness TH_2 of the second insulating layer 212_2 in the second direction D2. The second insulating layer 212_2 may be formed of any insulating material or polymer including at least one of PET, PP, PE, PS, PI, and PU. The shape of the second insulating layer 212_2 may be a rectangle. But the shape of the second insulating layer 212_2 is not limited to a rectangle and may be various other shapes such as any polygon or a circle.

A second substrate 214_2 may be disposed on the second insulating layer 212_2. For example, the second substrate 214_2 may extend in the first direction D1 and be disposed on one surface of the second insulating layer 212_2. In some embodiments, the second substrate 214_2 may cover one surface of the second insulating layer 212_2. The second substrate 214_2 may overlap with the second insulating layer 212_2 in the second direction D2. A thickness TH_4 of the second substrate 214_2 in the second direction D2 may be greater than the thickness TH_2 of the second insulating layer 212_2 in the second direction D2.

The second substrate 214_2 may be formed from a conductive metal material. For example, the second substrate 214_2 may be formed from copper, a copper alloy, nickel, or a nickel alloy. In other examples, the second substrate 214_2 may be formed from aluminum or an aluminum alloy. The first substrate 214_1 and the second substrate 214_2 may be integrally formed to constitute a portion of a substrate 214 of the electrode 200 for a secondary battery. That is, the second substrate 214_2 may extend from the first substrate 214_1 in the first direction D1. Here, the thickness TH_3 of the first substrate 214_1 in the second direction D2 may be less than the thickness TH_4 of the second substrate 214_2 in the second direction D2. Accordingly, at least a portion of the second substrate 214_2 may overlap with the first insulating layer 212_1 in the first direction D1. When the protrusion portion 220 corresponds to the electrode tab of the electrode 200 for a secondary battery, the stability and life characteristics of the electrode 200 for a secondary battery may be improved by providing the thickness TH_4 of the second substrate 214_2 of the protrusion portion 220 in the second direction D2.

The composite portion 210 may further include a third substrate 214_3 and a second active material layer 216_2. The third substrate 214_3 may be disposed on the first insulating layer 212_1. For example, the third substrate 214_3 may extend in the first direction D1 and be disposed on a second surface of the first insulating layer 212_1. Here, the second surface of the first insulating layer 212_1 may be a surface facing the first surface of the first insulating layer 212_1. The third substrate 214_3 may cover the second surface of the first insulating layer 212_1. The third substrate 214_3 may overlap with the first insulating layer 212_1 in the second direction D2. The third substrate 214_3 may be formed from a conductive metal material. For example, the third substrate 214_3 may be formed from copper, a copper alloy, nickel, or a nickel alloy. In other examples, the third substrate 214_3 may be formed from aluminum or an aluminum alloy. The first substrate 214_1 and the third substrate 214_3 may be formed from the same conductive metal material.

A second active material layer 216_2 may be disposed on the third substrate 214_3. For example, the second active material layer 216_2 may extend in the first direction D1 and be disposed on one surface of the third substrate 214_3. In some embodiments, the second active material layer 216_2 may cover one surface of the third substrate 214_3. The second active material layer 216_2 may overlap with the second substrate 214_2 and the first insulating layer 212_1 in the second direction D2. The second active material layer 216_2 may be applied on the third substrate 214_3so as to form a coating portion of the electrode 200 for a secondary battery. The second active material layer 216_2 may include a transition metal oxide or the like. The second active material layer 216_2 may not overlap with the protrusion portion 220 in the second direction D2. That is, the second active material layer 216_2 may extend only an end of the composite portion 210 in the first direction D1. The first active material layer 216_1 and the second active material layer 216_2 may constitute an active material layer 216 of the electrode 200 for a secondary battery. Thus, the composite portion 210 may include the active material layer 216 disposed on the first substrate 214_1compositeand the active material layer 216 disposed on the third substrate 214_3.

The protrusion portion 220 may further include a fourth substrate 214_4. The fourth substrate 214_4 may be disposed on the second insulating layer 212_2. For example, the fourth substrate 214_4 may extend in the first direction D1 and be disposed a second surface of the second insulating layer 212_2. Here, the second surface of the second insulating layer 212_2 face a first surface of the second insulating layer 212_2. The fourth substrate 214_4 may cover the second surface of the second insulating layer 212_2and overlap with the second insulating layer 212_2 in the second direction D2.

The fourth substrate 214_4 may be formed from a conductive metal material. For example, the fourth substrate 214_4 may be formed from copper, a copper alloy, nickel, or a nickel alloy. In other examples, the fourth substrate 214_4 may be formed from aluminum or an aluminum alloy. The fourth substrate 214_4 may be formed from the same conductive metal material as the second substrate 214_2. The third substrate 214_3 and the fourth substrate 214_4 may be integrally formed to constitute a portion of the substrate 214 of the electrode 200 for a secondary battery. That is, the fourth substrate 214_4 may extend from the third substrate 214_3 in the first direction D1.

As disclosed above, the first to fourth substrates 214_1, 214_2, 214_3, and 214_4 may be formed from the same conductive metal material. For example, when the electrode 200 for a secondary battery is a positive electrode, the first to fourth substrates 214_1, 214_2, 214_3, and 214_4 may be formed from aluminum or an aluminum alloy. In other examples, when the electrode 200 for a secondary battery is a negative electrode, the first to fourth substrates 214_1, 214_2, 214_3, and 214_4 may be formed from copper, a copper alloy, nickel, or a nickel alloy. In addition, the first substrate 214_1 and the second substrate 214_2 may be integrally formed and may be disposed on a first surface of the insulating layer 212. The third substrate 214_3 and the fourth substrate 214_4 may be integrally formed and may be disposed on a second surface of the insulating layer 212 that faces the first surface of the insulating layer 212. The first to fourth substrates 214_1, 214_2, 214_3, and 214_4 may constitute the substrate 214 of the electrode 200 for a secondary battery.

Because the weight of the electrode 200 for a secondary battery and the amount of metal used are reduced by the insulating layer 212 of the electrode 200 for a secondary battery as described above, the manufacturing cost of the secondary battery may be reduced. Further, even if damage such as penetration of the secondary battery occurs, short circuits are effectively prevented by the insulating layer 212. Thus, the safety and life characteristics of the secondary battery may be improved.

Referring to FIG. 3 and the embodiment depicted in FIG. 5, the electrode 200 for a secondary battery may include the composite portion 210 and the protrusion portion 220. For convenience, the following descriptions will focus on configurations that are different from those described above with reference to FIGS. 1-4. In an embodiment, the protrusion portion 220 may include a first region R_1 and a second region R_2 that extends from the first region R_1 in the first direction D1 and in which at least a portion of the second substrate 214_2 is bent toward the second insulating layer 212_2 in the second direction D2. Here, a thickness of the second substrate 214_2 disposed in the second region R_2 in the second direction D2 may be less than a thickness of the second substrate 214_2 disposed in the first region R_1 in the second direction D2.

In this embodiment, the protrusion portion 220 corresponds to an electrode tab of the electrode 200 for a secondary battery. By partially reducing the thickness of the protrusion portion 220 by the second region R_2, a lead tab may be easily coupled to the protrusion portion 220.

Referring to FIG. 3 and the embodiment depicted in FIG. 6, the electrode 200 for a secondary battery may include the composite portion 210 and the protrusion portion 220. For convenience, the following descriptions will focus on configurations that are different from those described above with reference to FIGS. 1-5. In this embodiment, the protrusion portion 220 includes the second substrate 214_2, but the protrusion portion 220 does not include the insulating layer 212. That is, the second substrate 214_2 may be formed by extending the first substrate 214_1 in the first direction D1. Alternatively, the second substrate 214_2 may be formed by extending the third substrate 214_3 in the first direction D1. The first to third substrates 214_1, 214_2, and 214_3 may be integrally formed, and the first to third substrates 214_1, 214_2, and 214_3 may surround the insulating layer 212.

Referring to FIG. 3 and the embodiment depicted in FIG. 7, the electrode 200 for a secondary battery may include the composite portion 210 and the protrusion portion 220. For convenience, the following descriptions will focus on configurations that are different from those described above with reference to FIGS. 1-6. In this embodiment, the protrusion portion 220 includes the second substrate 214_2, but the protrusion portion 220 does not include the insulating layer 212. That is, the second substrate 214_2 may be formed by extending the first substrate 214_1 in the first direction D1or by extending the third substrate 214_3 in the first direction D1. The first to third substrates 214_1, 214_2, and 214_3 may be integrally formed and may surround the insulating layer 212. The second substrate 214_2 may include a first region R_1 and a second region R_2 that extends from the first region R_1 in the first direction D1 and in which at least a portion of the second substrate 214_2 is bent toward the insulating layer 212 in the second direction D2.

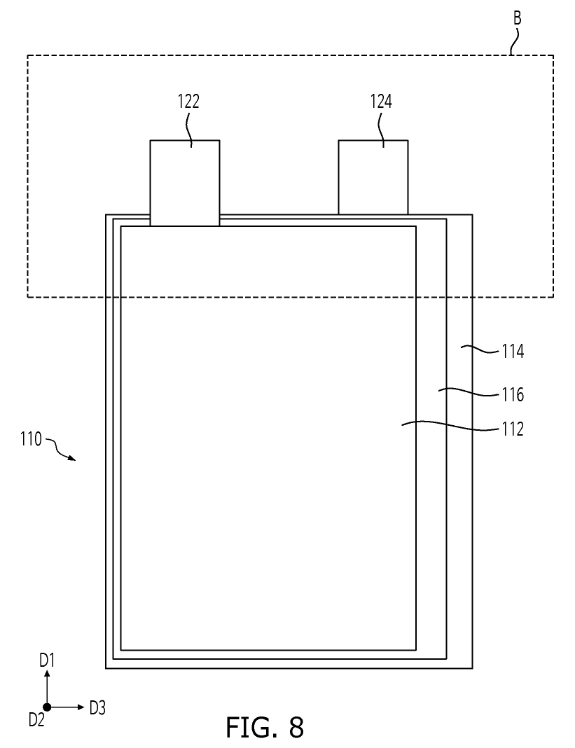

FIGS. 8-10 show steps of a method of manufacturing a secondary battery according to some embodiments of the present disclosure. Here, the secondary battery may correspond to the secondary battery 100 disclosed in FIG. 1.

Referring to FIG. 8, the electrode assembly 110 may be formed by disposing the separator 116 between the first electrode 112 and the second electrode 114. The first electrode 112 may include the first electrode tab 122 and the second electrode 114 may include the second electrode tab 124. The electrode assembly 110 may be formed by stacking first electrodes 112, second electrodes 114, and separators 116 disposed between the first electrodes 112 and the second electrodes 114. The first electrode 112 and the second electrode 114 may have opposite polarities. The first electrode 112 and the second electrode 114 may have the same or similar configuration as the electrode 200 for a secondary battery described above with reference to FIGS. 3-7. For example, the first electrode tab 122 connected to the first electrode 112 may correspond to the protrusion portion 220 described above with reference to FIGS. 3-7. And the second electrode tab 124 connected to the second electrode 114 may also correspond to the protrusion portion 220 described above with reference to FIGS. 3-7.

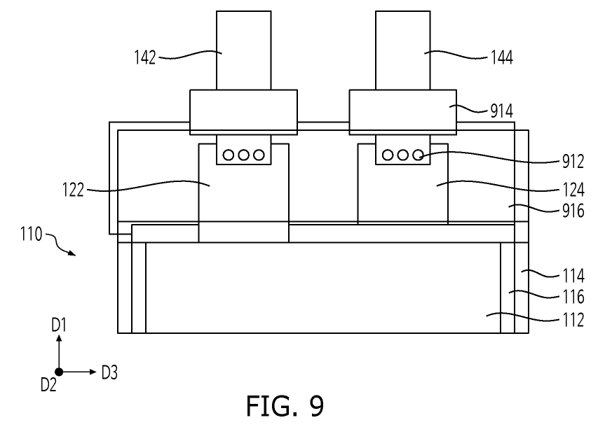

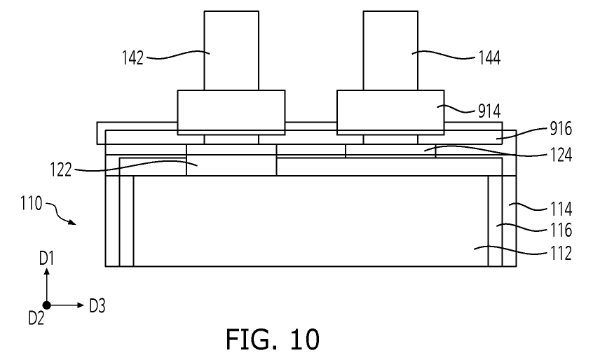

FIGS. 9 and 10 illustrate steps of a method of manufacturing the secondary battery after the step illustrated in FIG. 8. Specifically, FIGS. 9 and 10 depict a region B of FIG. 8. Referring to FIG. 9, the first lead tab 142 may be coupled to the first electrode tab 122, and a second lead tab 144 may be coupled to the second electrode tab 124. More specifically, the first lead tab 142 may be weld-coupled to the first electrode tab 122, and the second lead tab 144 may be weld-coupled 912 to the second electrode tab 124. Thereafter, an insulating film 916 covering the first electrode tab 122 and the second electrode tab 124 may be attached. The insulating film 916 may include any insulating material, such as polypropylene. Thereafter, a tab film 914 may be attached on the first lead tab 142 and the second lead tab 144. The tab film 914 may include any insulating material, such as polypropylene. In the embodiment depicted in FIGS. 9 and 10, a configuration in which the electrode tab and the lead tab are separately connected is shown. But the present disclosure is not limited to such a configuration, and the electrode tab and the lead tab may be integrally formed.

Referring to FIG. 10, the first electrode tab 122 and the second electrode tab 124 may be bent. After connecting or coupling the first lead tab 142, the second lead tab 144, the tab film 914, and the insulating film 916 to the electrode assembly 110, the structure may be accommodated in a case (for example, the case 130 of FIG. 1) to make a secondary battery.

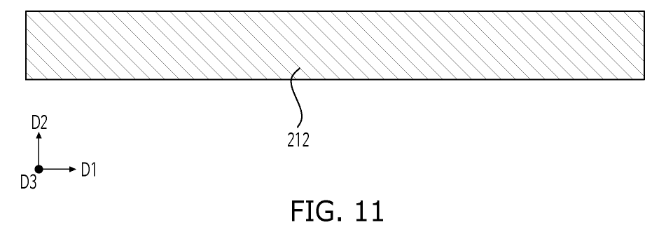

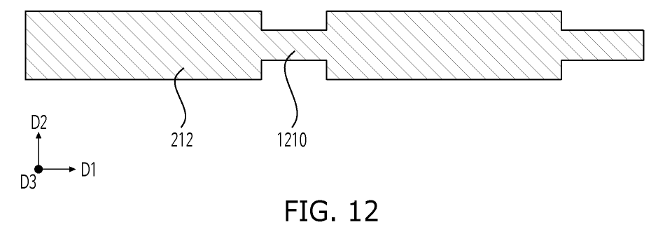

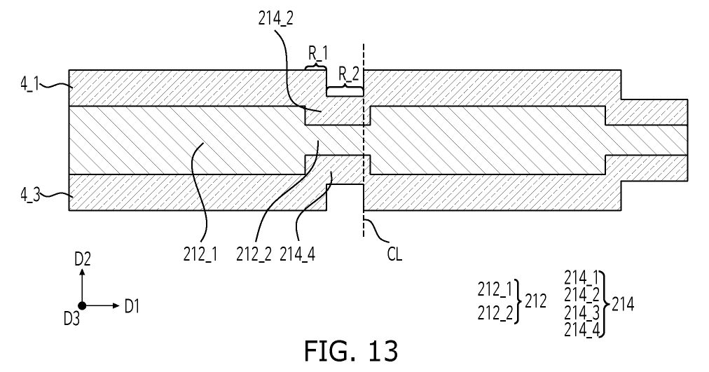

FIGS. 11-13 show steps of a method of manufacturing an electrode for a secondary battery according to embodiments of the present disclosure. Referring to FIGS. 11-13, after preparing an insulating layer 212 extending in the first direction D1, compressed portions 1210, which are spaced apart at intervals along the first direction D1, may be formed in the insulating layer 212. The insulating layer 212 may include an insulating material such as at least one of PET, PP, PE, PS, PI, and PU. The compressed portions 1210 may be formed by compressing portions of the insulating layer 212 in the second direction D2, with the compressed portions 1210 thereby form the second insulating layers 212_2.

Next, an electrode for a secondary battery may be formed by disposing a substrate 214 on the insulating layer 212. For example, the insulating layer 212 in which the compressed portion 1210 is not formed may be referred to as a first insulating layer 212_1, and the insulating layer 212 in which the compressed portion 1210 is formed may be referred to as a second insulating layer 212_2. The first substrate 214_1 and the third substrate 214_3 may be disposed on the first insulating layer 212_1. A second substrate 214_2 and a fourth substrate 214_4 may be disposed on the second insulating layer 212_2. The first substrate 214_1 and the second substrate 214_2 may be integrally formed, and the third substrate 214_3 and the fourth substrate 214_4 may be integrally formed.

The second substrate 214_2 and the fourth substrate 214_4 disposed on the second insulating layer 212_2 may include a first region R_1 and a second region R_2 that is bent toward the second insulating layer 212_2 in a second direction D2 intersecting the first direction D1. For example, the second region R_2 may be formed by compressing a portion of the second substrate 214_2 and the fourth substrate 212_4. Alternatively, the second region R_2 may be formed by depositing the second substrate 214_2 and the fourth substrate 212_4 on the second region R_2. Here, a thickness in the second direction D2 where the second substrate 214_2 and the fourth substrate 212_4 are deposited may be less than a thickness of the first substrate 214_1 and the third substrate 214_3 in the second direction D2.

Next, after cutting along a cutting line CL, an electrode for a secondary battery may be formed by applying an active material layer on the first substrate 214_1 and the third substrate 214_3. For example, the electrode 200 for a secondary battery shown in FIGS. 4-5 may be made through the manufacturing method as depicted in FIGS. 11-13. For example, the electrode 200 for a secondary battery shown in FIG. 4 may be made by depositing the second substrate 214_2 on the compressed portion 1210 and then further depositing the first substrate 214_1 and the second substrate 214_2, which are integrally formed along the first direction D1.

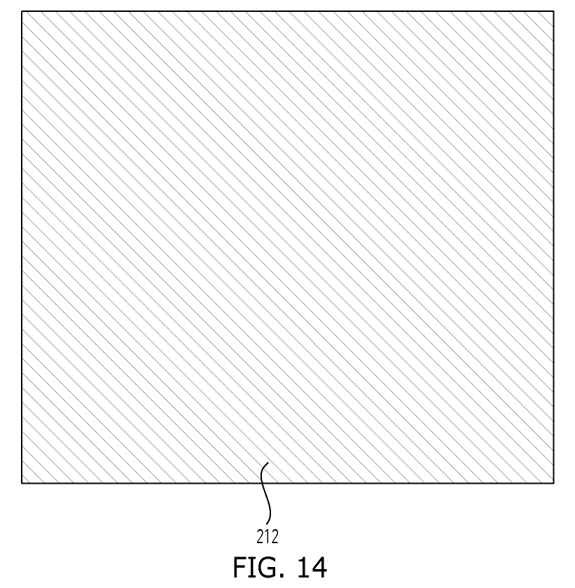

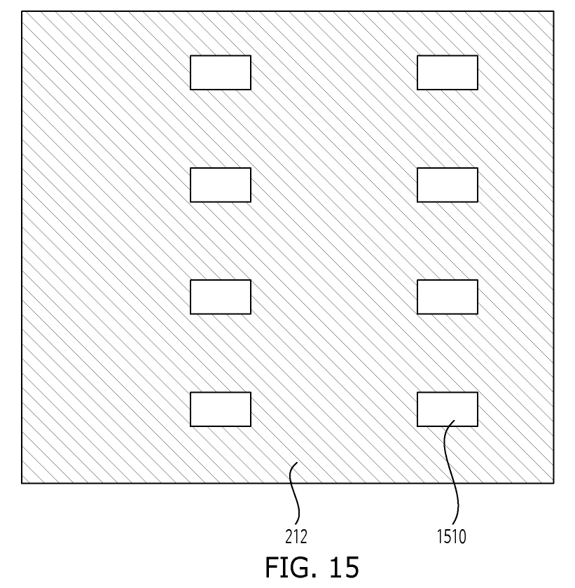

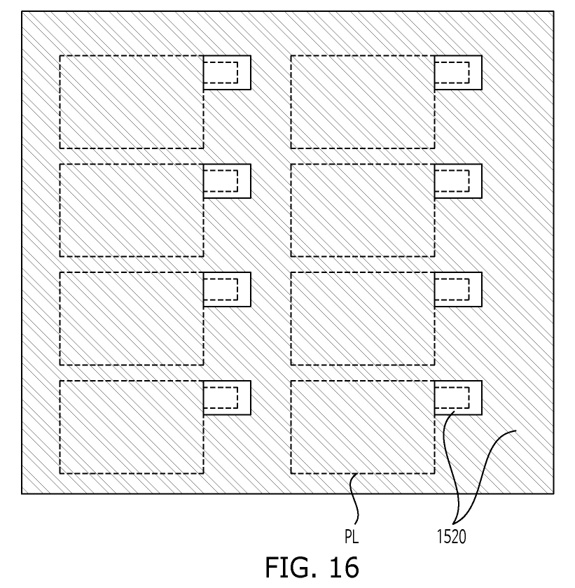

FIGS. 14-16 show steps of a method of manufacturing an electrode for a secondary battery according to embodiments of the present disclosure. Referring to FIGS. 14-16, after preparing an insulating layer 212, one or more through-portions 1510 spaced apart at intervals may be formed in the insulating layer 212. The insulating layer 212 may include an insulating material such as at least one of PET, PP, PE, PS, PI, and PU. The insulating layer 212 may extend in a plane having a polygonal shape such as a square or a rectangle. The through-portion 1510 may be formed by stamping the insulating layer 212. In the illustrated embodiment, the through-portion 1510 has a rectangular shape. But in other embodiments the through-portion 1510 may be formed in other shapes such as a circle, an ellipse, or the like.

Next, substrates 1520 may be disposed on the insulating layer 212 and in the through-portions 1510. For example, the substrates 1520 may be disposed on both surfaces of the insulating layer 212 and in the through-portions 1510. The substrates 1520 may correspond to the substrate 214 of the electrode 200 for a secondary battery described above with reference to FIGS. 6-7. Then, electrodes for a secondary battery may be formed by punching along punching lines PL. For example, the electrode 200 for a secondary battery described above with reference FIGS. 6-7 may be made through the method of manufacturing an electrode for a secondary battery according to the embodiments depicted in FIGS. 14-16.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. An electrode for a secondary battery comprising:
a composite portion comprising a first insulating layer, a first substrate disposed on the first insulating layer, and an active material layer disposed on the first substrate; and
a protrusion portion comprising a second insulating layer extending in a first direction from the first insulating layer and a second substrate disposed on the second insulating layer,
wherein a thickness of the first insulating layer in a second direction intersecting the first direction is greater than a thickness of the second insulating layer in the second direction.

2. The electrode for a secondary battery as claimed in claim 1, wherein a thickness of the first substrate in the second direction is less than a thickness of the second substrate in the second direction.

3. The electrode for a secondary battery as claimed in claim 1, wherein the first insulating layer and the second insulating layer are integral, and
wherein the first substrate and the second substrate are integral.

4. The electrode for a secondary battery as claimed in claim 1, wherein at least a portion of the second substrate overlaps the first insulating layer in the first direction.

5. The electrode for a secondary battery as claimed in claim 1, wherein the protrusion portion comprises:
a first region; and
a second region extending from the first region in the first direction, and
wherein at least a portion of the second substrate in the second region is bent in the second direction and toward the second insulating layer in the second direction.

6. The electrode for a secondary battery as claimed in claim 5, wherein a thickness of the second substrate in the second region in the second direction is less than a thickness of the second substrate in the first region in the second direction.

7. The electrode for a secondary battery as claimed in claim 1, wherein a length of the protrusion portion in a third direction intersecting each of the first direction and the second direction is less than a length of the composite portion in the third direction.

8. The electrode for a secondary battery as claimed in claim 1, wherein the first insulating layer comprises at least one of polyethylene terephthalate (PET), polypropylene (PP), polyethylene (PE), polystyrene (PS), polyamide (PI), and/or polyurethane (PU).

9. The electrode for a secondary battery as claimed in claim 1, wherein the active material layer does not overlap with the protrusion portion in the second direction.

10. A secondary battery comprising:
a case; and
an electrode assembly accommodated in the case, the electrode assembly comprising a first electrode, a second electrode, and a separator disposed between the first electrode and the second electrode,
wherein the first electrode comprises:
a composite portion comprising a first insulating layer, a first substrate disposed on the first insulating layer, and an active material layer disposed on the first substrate; and
a protrusion portion comprising a second insulating layer extending in a first direction from the first insulating layer and a second substrate disposed on the second insulating layer, and
wherein a thickness of the first insulating layer in a second direction intersecting the first direction is greater than a thickness of the second insulating layer in the second direction.

11. The secondary battery as claimed in claim 10, wherein a thickness of the first substrate in the second direction is less than a thickness of the second substrate in the second direction.

12. The secondary battery as claimed in claim 10, wherein the first insulating layer and the second insulating layer are integral, and
the first substrate and the second substrate are integral.

13. The secondary battery as claimed in claim 10, wherein at least a portion of the second substrate overlaps with the first insulating layer in the first direction.

14. The secondary battery as claimed in claim 10, wherein the protrusion portion comprises:
a first region; and
a second region extending from the first region in the first direction, and
wherein at least a portion of the second substrate in the second region is bent in the second direction and toward a center of the second insulating layer.

15. The secondary battery as claimed in claim 14, wherein a thickness of the second substrate in the second region in the second direction is less than a thickness of the second substrate in the first region in the second direction.

16. The secondary battery as claimed in claim 10, wherein a length of the protrusion portion in a third direction intersecting each of the first direction and the second direction is less than a length of the composite portion in the third direction.

17. The secondary battery as claimed in claim 10, wherein the first insulating layer comprises at least one of polyethylene terephthalate (PET), polypropylene (PP), polyethylene (PE), polystyrene (PS), polyamide (PI), and/or polyurethane (PU).

18. The secondary battery as claimed in claim 10, wherein the active material layer does not overlap with the protrusion portion in the second direction.

19. The secondary battery as claimed in claim 10, further comprising a lead tab disposed on the second substrate.

20. The secondary battery as claimed in claim 19, wherein the lead tab is coupled to the second substrate by welding.
